(19) United States
(12) Patent Application Publication
(10) Pub. No.: US 2016/0312122 A1
(43) Pub. Date: Oct. 27, 2016

(54) DEVICE FOR PRODUCING GREEN COAL FOR AGRICULTURAL USE

(71) Applicant: Rawya Lotfy Mansour, Princesse Charlotte (MC)

(72) Inventor: Rawya Lotfy Mansour, Princesse Charlotte (MC)

(21) Appl. No.: 15/101,706

(22) PCT Filed: Nov. 28, 2014
(86) PCT No.: PCT/EP2014/075982

§ 371 Date: Jun. 3, 2016

(30) Foreign Application Priority Data
Dec. 4, 2013 (FR) 13 62090

(51) Int. Cl. C10B 37/00; B01F 15/06; B01F 7/18; C10B 47/18; C10B 53/02

(52) U.S. Cl. CPC C10B 37/00; C10B 47/18; C10B 53/02; B01F 7/183; B01F 15/065; B01F 2015/062

(57) ABSTRACT

The present invention concerns device for producing green coal for agricultural use from organic agricultural materials comprising: a container (5) suitable for receiving the organic materials, an enclosure (1) enclosing the container (5) and delimiting an intermediate space around the container (5), a system for heating the intermediate space and a rotary stirring system configured to stir the organic materials placed in the container (5), characterised by the fact that the rotary stirring system comprises a plurality of blades (15) that are fixed relative to the container (5) and a plurality of blades (14a, 14b) that are mobile in rotation relative to the container (5), the plurality of fixed blades (15) being distributed between at least two stages of fixed blades (15) along the axis (13) of rotation, the plurality of mobile blades (14a, 14b) being distributed between at least two stages of mobile blades along the axis (13) of rotation, the stages of fixed blades and the stages of mobile blades alternating along the axis (13) of rotation.

The present invention relates to a device for producing charcoal for agricultural use. Charcoal for agricultural use is generally referred to as “biochar”, which is the contraction of the terms bio and charcoal, biochar being used for improving or restoring soils, in particular cultivated land, in a tropical environment or not.

The present invention enables this charcoal for agricultural use to be manufactured from agricultural organic materials, for example rice straw, although this case is not limitative. It is possible in particular to use other waste of agricultural origin or any other form of biomass. In general terms green charcoal is spoken of.

In this field, the applicant has already proposed, through the publication WO-A-2012/059113, apparatus for manufacturing charcoal for agricultural use. According to this publication, a container is formed to receive the organic material, for example rice straw, and for effecting a transformation in which the organic material is subjected to an addition of heat so as to effect a reaction without oxygen, similar to pyrolysis, for reducing the organic materials into carbonaceous products in the form of biochar. The container receiving the organic material is surrounded by a peripheral space of an enclosure subjected to high temperature, for example by an oil burner. During this operation, stirring may be produced. At the end of the heating cycle, the organic material thus transformed is cooled and then discharged through an outlet situated at the bottom part of the installation.

Overall, the installation described above according to the prior art gives satisfaction in that it makes it possible to effectively produce substantial quantities of charcoal for agricultural use quickly, and in particular because of the in situ cooling by water spray. Nevertheless, the applicant has found that this existing technique could be improved, in particular with regard to the efficacy of the stirring imposed on the organic materials during the carbonisation phase.

The object of the present invention is to propose such an improvement.

The document JP-A-2005/146119 shows a machine provided with a plurality of rotary blades in a mixing space. Fixed projections, bearing the reference 16, are present on the circumference of the container delimiting the stirring volume. The stirring does however remain limited.

According to one aspect of an embodiment of the invention, a device for producing charcoal for agricultural use from agricultural organic materials is presented, comprising a container able to receive the organic materials, an enclosure enclosing the container and delimiting an intermediate space around the container, a system for heating the intermediate space and a rotary stirring system configured so as to stir the organic materials placed in the container.

Advantageously, the rotary stirring system comprises a plurality of blades fixed relative to the container and a plurality of blades able to rotate relative to the container, the plurality of fixed blades being distributed in at least two stages of fixed blades along the rotation axis, the plurality of moving blades being distributed in at least two stages of moving blades along the rotation axis, the fixed blade stages and the moving blade stages being in alternation along the rotation axis.

Thus, by virtue of the invention, the stirring system is distributed between a part fixed relative to the container and a moving part. The organisation of this stirring over the height of the container affords good distribution of the stirring and therefore better application of the addition of heat issuing from the heating of the enclosure, over the whole of the volume of agricultural organic materials present in the container. The result is an improved pyrolysis, namely more complete and more rapid, and less tamping effect during the pyrolysis, which makes it possible to distribute the stirring force over a plurality of stages of moving blades without risking any problems of breakage or oversizing of the drive.

Advantageously, the spacing between any two adjacent stages from respectively the fixed blade stages and the moving blade stages is between 50 and 150 mm.

Moreover, the length of the fixed blades may be greater than 50% of the radius of the container when the latter has a circular cross section in a plane perpendicular to the rotation axis. In addition or as an alternative, this length is, at least for one of the fixed blades, greater than 90% of the radius in a preferred case.

By virtue of the above arrangements, the stirring is made effective. Whereas JP-A-2005/146119 suggests lateral attachment points by means of the projections 16, of small size, the invention proposes fixed blades greatly projecting towards the stirring space. These blades participate fully in the mixing, including in the vicinity of the rotation axis, which is more effective, whereas the current techniques are simply oriented towards stirrings mainly made by the rotary parts.

When, in addition, the spacing between any two adjacent stages from respectively the fixed blade stages and the moving blade stages is between 50 and 150 mm, stirring is obtained that is both effective and does not increase the torque of the rotation of the moving parts too greatly.

Other aims and advantages will emerge during the following description, which presents a preferred embodiment of the invention that is illustrative but non-limitative.

The accompanying drawings are given by way of examples and are not limitative of the invention. They represent only one embodiment of the invention and will make it possible to understand it easily.

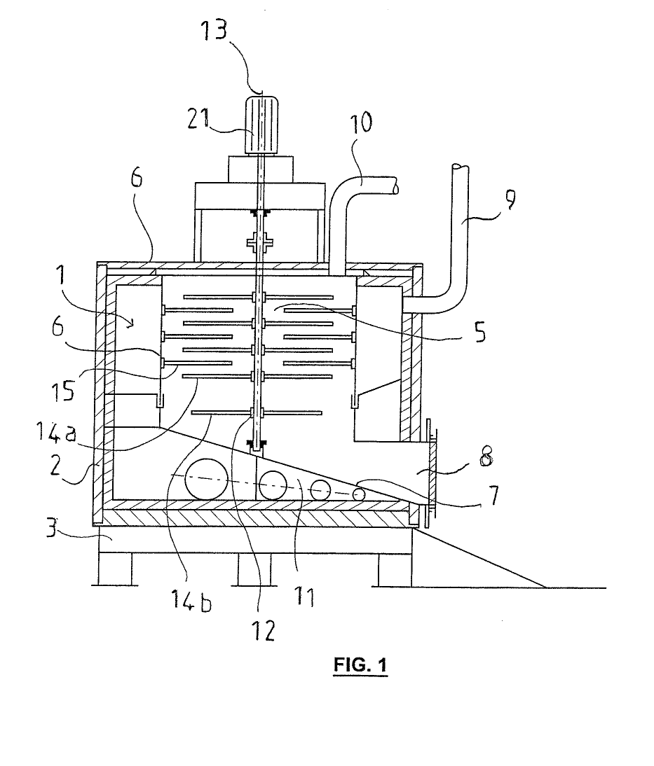

FIG. 1 presents a view in cross section of an embodiment of the device of the invention in its entirety.

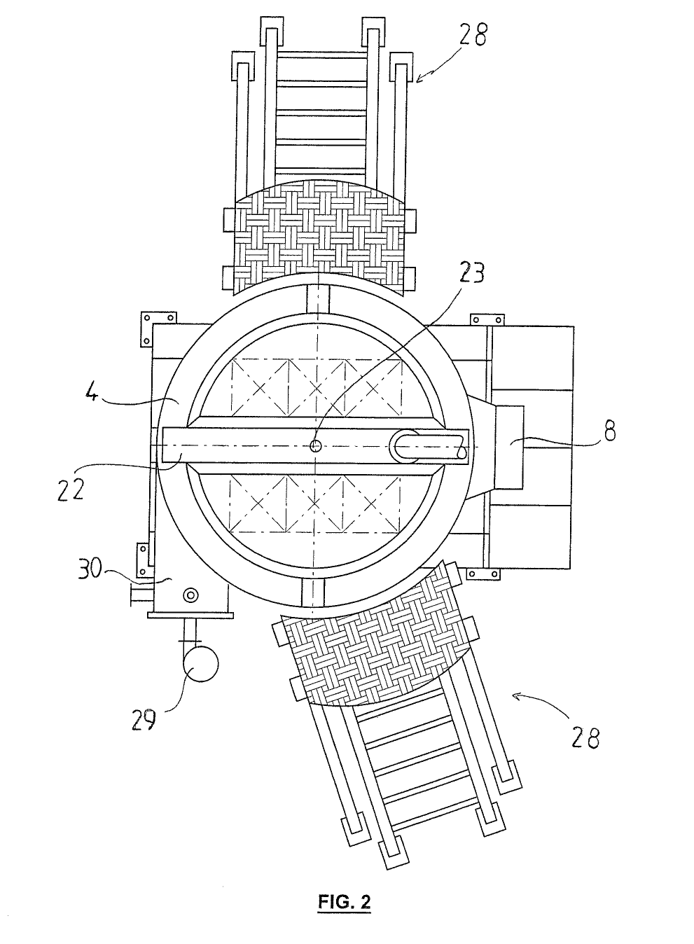

FIG. 2 presents a plan view of the device according to the embodiment in FIG. 1.

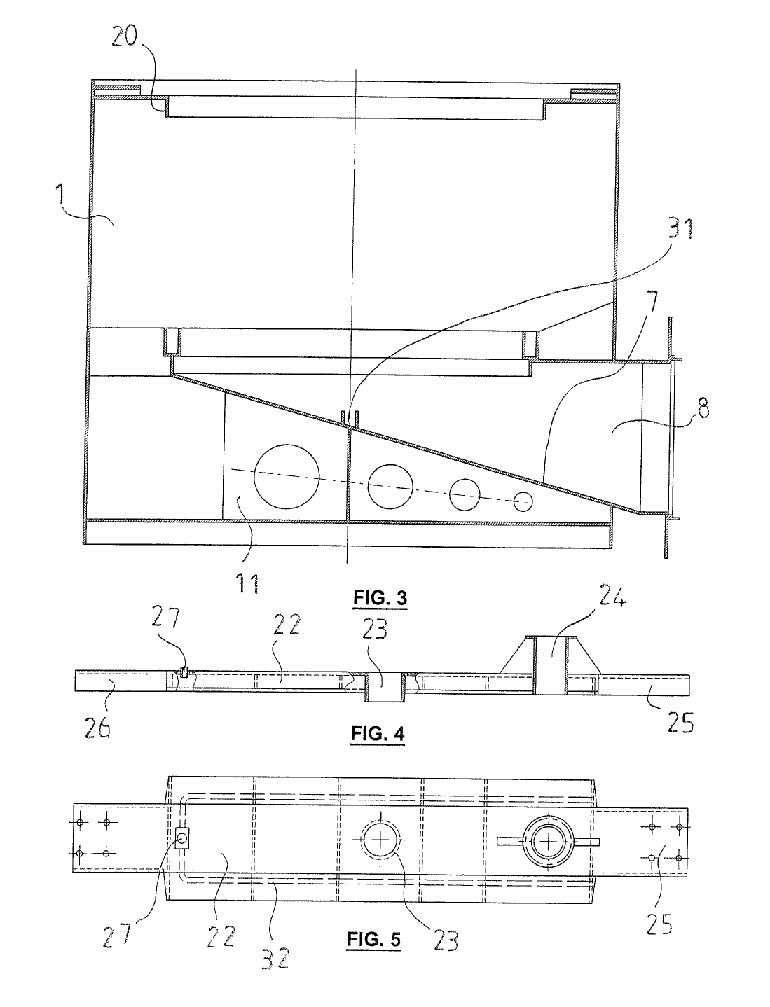

FIG. 3 illustrates an example of formation of part of the enclosure and of the container.

FIG. 4 and FIG. 5 present respectively a view in cross section and a plan view of a beam part of the invention.

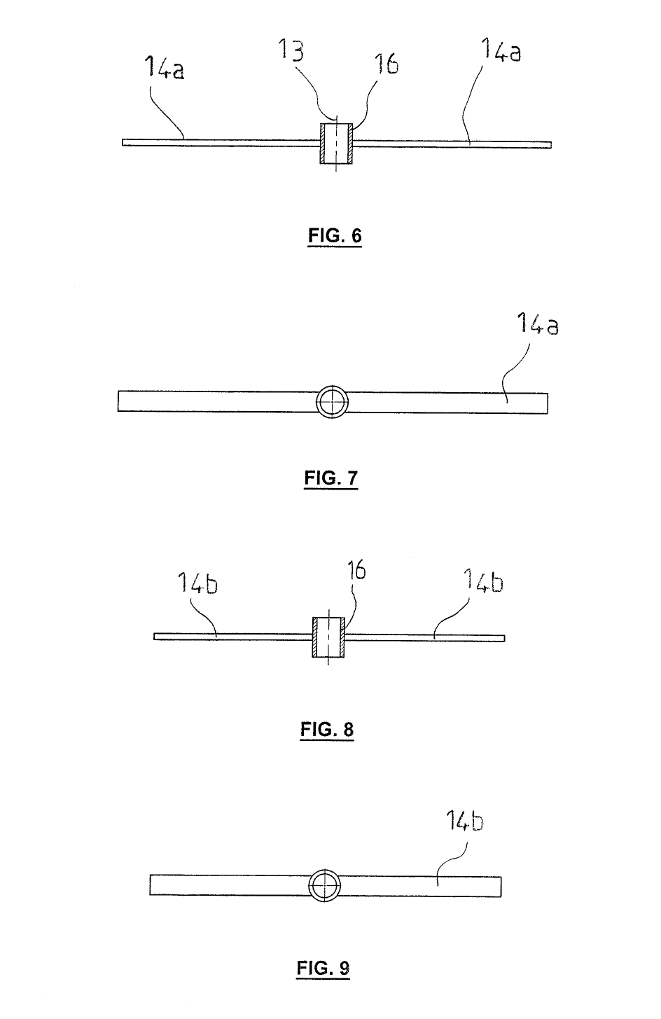

FIGS. 6 and 7 present respectively a view in cross section and a plan view of a blade system.

FIGS. 8 and 9 show respectively a view in cross section and a plan view of another blade system that can be used according to the invention.

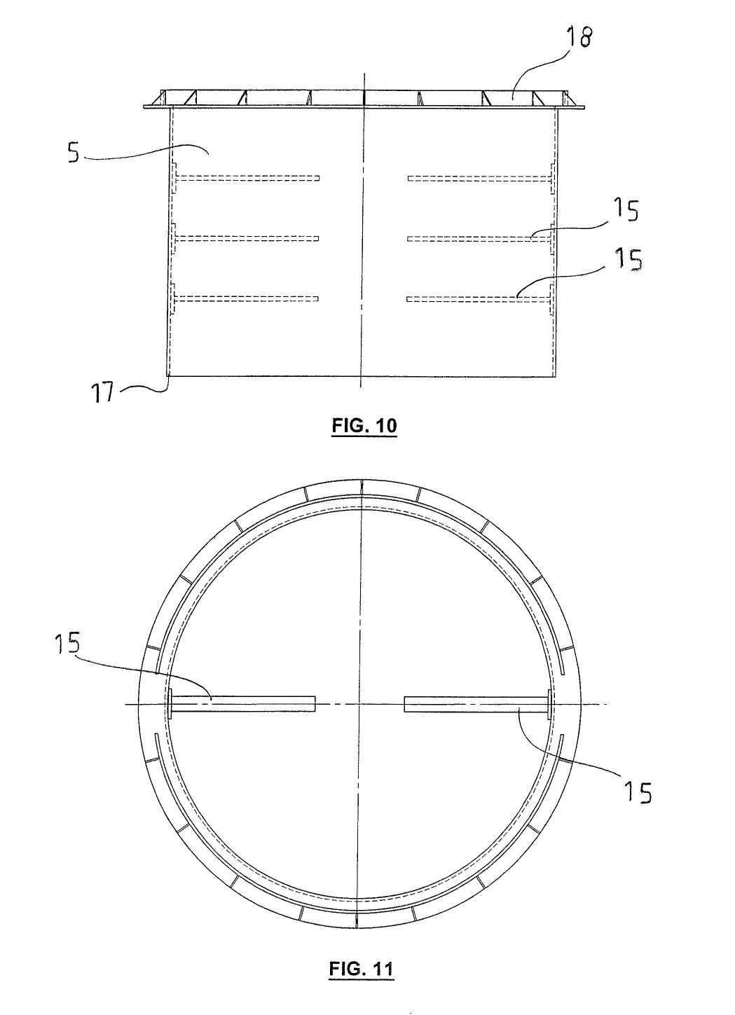

FIG. 10 presents a side view of an embodiment of a container body and FIG. 11 gives a plan view thereof.

Before going into details in the description of embodiments of the invention, in particular in support of the drawings, features are introduced below that may optionally present the invention individually or in accordance with any combination with each other:
the rotary stirring system comprises four stages of moving blades and three stages of fixed blades;
a stage of fixed blades comprises two blades having the same longitudinal axis;
the lateral wall of the container has a circular cross section perpendicular to the rotation axis;
the fixed blades of at least one fixed-blade stage are spaced apart by a distance of less than 25% of the diameter of the circular cross section;
at least one moving-blade stage comprises two blades that are symmetrical in relation to the rotation axis;
the length of the moving blades of the at least one stage is greater than 75% of the radius of the circular cross section;
the container comprises a bottom wall inclined downwards in the direction of an outlet conduit;
the rotary stirring system comprises a stage of additional moving blades at a height level, along the rotation axis, corresponding to a junction zone between the lateral wall of the container and the bottom wall;
the length of the additional moving blades is less than the length of the moving blades of the moving-blade stages;
the spacing between any two adjacent stages from respectively the fixed-blade stages and the moving-blade stages is between 50 and 150 mm;
the fixed blades are all situated in the same plane containing the rotation axis;
the moving blades are mounted on a single shaft;
the shaft is mounted for rotation on the bottom wall;
the shaft is mounted for rotation on a beam directed transversely to the rotation axis;
the beam comprises a circuit for injecting a cooling fluid into the container;
the beam is surmounted by a cover closing the top opening of the container;
the moving blades are all situated in the same plane containing the rotation axis;
the length of the fixed blades may be greater than 50% of the radius of the container when the latter has a circular cross section in a plane perpendicular to the rotation axis. In addition or as an alternative, this length is, at least for one of the fixed blades, greater than 90% of the radius in a preferred case.

In the example given in FIG. 1, the device is overall in the form of an enclosure 1 having an external wall 2 advantageously covered with a thermally insulating cladding, for example using glass straw and/or refractory materials and/or ceramic materials. The insulating external wall 2 advantageously covers at least part of the lateral and bottom periphery of the enclosure 1. The assembly further comprises a cover 4, more particularly visible in plan view in FIG. 2, with the case of a system substantially with a circular cross section. The cover 4 affords access to the internal space of the enclosure 1, the components of which will be described in more detail subsequently. Opposite the cover 4, the device preferentially comprises a base 3 constituting a structure for the device to bear on a support, for example the ground. The bottom of the enclosure 1 is advantageously flat.

The space of the enclosure 1 receives a container 5 composed, in the example in FIG. 1 and FIG. 10, of a body substantially elongate along an axis 13 and for example with a circular cross section so as to form a cylindrical body with its axis 13 preferentially vertical. At the bottom part of the container 5, the latter comprises in the example a bottom wall 7, for example in the form of an inclined plane, having a slope enabling the charcoal produced to descend by gravity from the body part of the container 5 in the direction of an outlet conduit 8 visible in FIGS. 1 and 2. It will be understood that organic materials such as rice straw can be admitted through the top end of the container 5 corresponding to that situated at the cover 5, imposing a transformation by pyrolysis on this material inside the body of the container 5 and discharging the charcoal for agricultural use thus produced through the outlet conduit 8.

In general terms, the reaction produced in the device according to the invention may satisfy conditions as presented in the aforementioned prior art WO-A-2012/059113. The device advantageously comprises:
a heating conduit 30 connected at a distal end to a burner 29, for example a gas or oil burner, so as to provide a high quantity of heat in a part of the enclosure 1 situated between the external wall 2 and the external face of the container 5. In this intermediate space, it is possible to produce heating of the organic materials in the absence of air so as to implement a carbonisation process. In this way powder referred to as biochar is produced. During this cycle, the gases issuing from the pyrolysis can be eliminated by means of a discharge conduit 10, either by recirculating them in order to effect pyrolysis used for heating the intermediate space of the enclosure 1, or by burning to the outside. Furthermore, a flue 9 connects the internal space of the enclosure 1 to the ambient air if required.

It will be understood that effective homogeneous pyrolysis of the organic materials serving as a basis for the manufacture of biochar is fundamental to the efficacy of the system. To this end, the invention comprises a specific stirring system in the container 5.

In particular, in the case depicted in FIG. 1, this system comprises a plurality of blades, some of which are fixed blades 15 and some of which are moving blades 14a, 14b, cooperating in a specific fashion in order to homogenise the stirring of the organic materials. More particularly, the container 5 is equipped on the internal wall of its cylindrical main body with a plurality of fixed-blade stages 15. In the case of FIGS. 10 and 11, the fixed blades 15 are each oriented on a diameter of the container 5 and are distributed symmetrically on a single diameter. The assembly is advantageously symmetrical along the rotation axis 13 of the moving blades 14a, 14b.

FIG. 10 shows the formation of three stages of fixed blades 15, for example distributed with a spacing, regular or not, of around 150 to 250 mm. A diameter of the container 5 of around 1300 mm may be suitable. The fixed blades 15 have for example a length of around 500 mm and advantageously in general terms have—for at least one of them and preferably each one—a length greater than 50% (and advantageously 90% for at least one of these blades 15) of the radius of the container 5. Moreover, so as to produce a sufficient obstacle to the descent of the organic materials along the container 5, the blades 15 of a fixed-blade stage are advantageously distant by less than 25% of the diameter of the circular cross section of the container 5. The invention does not exclude the formation of a large number of fixed blades at each stage or at some stages. The stirring system of the invention further comprises a part able to move relative to the container 5 with, in the example depicted in FIG. 1, four stages of blades 14a, one embodiment of which is visible more particularly in FIGS. 6 and 7. The moving blades may be produced in equally distributed stages, for example spaced apart by 200 mm. Each stage may comprise two blades 14a symmetrical about the rotation axis 13. Each blade stage advantageously comprises a mounting ring 16 enabling them to be mounted on a shaft 12 directed along the axis 13. It will be understood that it is advantageous for the moving-blade stages 14a to share the same shaft 12, which can thus easily be connected to a drive 21, for example with a motor and a gearbox and a coupling system. The drive 21 is, in the case in FIG. 1, situated above the cover 4, and a passage in the cover 4 enables the shaft 12 to pass through the inside of the container 5.

The blades depicted in FIGS. 6 and 7 are, advantageously like the fixed blades 15, directed perpendicular to the rotation axis 13. They are moreover symmetrical about the axis 13 in a preferred manner. Their dimensions are preferably configured so as to cover at least 75% of the radius of the container 5. In this way, as is clear from FIG. 1, a fixed-blade system and moving-blade system are formed, evenly distributing the stirring towards the centre of the container 5 and towards its periphery.

In one embodiment, the fixed blades 15 are organised in the same plane containing the axis 13 and advantageously vertical. Likewise, the moving blades 14a are advantageously included in the same plane containing the axis 13 and advantageously vertical, this plane being rotary relative to the container 5. In the bottom part of the body of the container 5, it is possible to place a stage of additional blades 14b situated, in the case of FIG. 1, at the junction between the body part of the container 5, here cylindrical in shape, and the bottom wall part 7, the slope of which is directed towards the outlet conduit 8. An example of definition of additional blades 14b is presented in FIGS. 8 and 9. As with the blades 14a, a mounting ring 16 allows mounting of the shaft 12. The blades 14b are advantageously, like the previous ones, produced symmetrically about the axis 13 so as to be directed overall along a diameter of the container 5. By way of indication, the width of the fixed 15 and moving 14a, 14b blades may be between 40 and 60 mm for a container with a diameter of 1300 mm.

The shaft 12 is preferentially guided by means of a bearing 31, visible in FIG. 3, positioned on the bottom wall 7.

It should be noted that the container 5 may be formed so as to be easily mounted inside the enclosure 1. More precisely, as is clear in FIG. 3, the internal face of the enclosure 1 preferentially comprises, at its top end, at the opening, a rim 20 directed towards the inside and able to receive the application of the cylindrical body part of the container 5. The opposite part of the container 5, corresponding to the bottom edge 17 visible in FIG. 10, is for its part received, in the example in FIG. 3, by a groove 19 situated at the top end of the bottom wall 7. It should be noted that the rim 20 advantageously cooperates with a top edge 18 of the container 5, the whole making it possible to effectively partition the container 5 relative to the intermediate space defined between the container 5 and the external wall 2 of the enclosure 1. A reinforcement 11 in the form of a square bracket stiffens the bottom wall 7, as can be seen in FIG. 3.

According to another aspect of the invention, the device comprises a beam 22 visible in FIGS. 4 and 5 in the form of an elongate element that can be attached to the top end of the container 5 between the container 5 and the cover 4. More particularly, the beam 22 as depicted comprises first and second ends 25, 26 that can be fixed to the periphery of the enclosure 1. The intermediate part of the beam 22 fits on top of the opening of the container 5. Advantageously, the beam 22 is directed along a diameter of the container 5. It preferentially comprises a guide hole 23 at the middle of its length so as to enable the shaft 12 to pass and to guide it. It will be understood that an effective guide system for the moving blades is formed in combination with the bearing 31. A hole 24 is also positioned on the beam 22 to effect the connection of the discharge duct 10.

Furthermore, the device according to the invention advantageously comprises a system for spraying the internal space of the container 5 with a cooling fluid such as water. Advantageously, this spray system is combined with the previously described beam 22. In the case depicted, a cooling inlet 27 supplies one or more pipes visible in the form of cooling tubes in FIG. 5. Each of these tubes preferentially comprises a plurality of openings directed towards the inside of the container 5 so as to distribute a spraying of water when this is useful to the manufacturing cycle. In particular, the spraying of water may take place at the end of manufacture so as to quickly cool the agricultural-use charcoal manufactured and to enable it to be discharged more quickly through the outlet conduit 8.

The device of the invention can be used according to a particularly effective method in which:
access is opened to the container 5 by movement of the cover 4;
the organic materials depicted in FIG. 2 in the form of balls of rice straw are placed inside the container 5. Access can be achieved through one or more access zones 28, also visible in FIG. 2. Once the organic materials are placed in the container 5, the cover can be folded down so as to hermetically close the interior space of the container 5. The intermediate space between the container 5 and the enclosure 1 is advantageously maintained hermetically at the top end of the device. When the seal is ensured, it is possible to activate the burner 29 so as to produce the pyrolysis reaction in the absence of air, enabling charcoal to be manufactured. Advantageously, the stirring system is active during at least some parts of the pyrolysis cycle so as to produce a better application of heat on the organic materials and greater efficacy of carbonisation. The vertical distribution of the blades and the use of fixed blades and moving blades afford a stirring that is both effective and efficient in terms of stirring relative to the drive energy necessary. At the end of manufacture, the biochar produced can be discharged by means of the outlet conduit 8. The transformation into charcoal and the stirring makes it possible to obtain a relatively powdery product that can easily move by gravity along the bottom wall 7 so as to discharge the product without difficulty.

### REFERENCES

1. Enclosure
2. External wall
3. Base
4. Cover
5. Container
6. Lateral wall
7. Bottom wall
8. Outlet conduit
9. Flue
10. Gas-discharge pipe
11. Reinforcement
12. Shaft
13. Axis
14a, 14b. Moving blade
15. Fixed blade
16. Mounting ring
17. Bottom edge
18. Top edge
19. Groove
20. Rim
21. Drive
22. Beam
23. Guide hole
24. Hole
25. First end
26. Second end
27. Cooling inlet
28. Access zone
29. Burner
30. Heating pipe
31. Bearing
32. Cooling tube

1. A device for producing green charcoal for agricultural use from agricultural organic materials, comprising:
a container able to receive the organic materials;
an enclosure enclosing the container and delimiting an intermediate space around the container;
a system for heating the intermediate space;
a rotary stirring system configured so as to stir the organic materials placed in the container;
wherein the rotary stirring system comprises a plurality of blades fixed relative to the container and a plurality of moving blades rotating relative to the container, the plurality of fixed blades being distributed in at least two stages of fixed blades along the rotation axis, the plurality of moving blades being distributed in at least two stages of moving blades along the rotation axis, the fixed-blade stages and the moving-blade stages being alternating along the rotation axis, and in that the spacing between any two adjacent stages from respectively the fixed-blade stages and the moving-blade stages is between 50 and 150 mm, and in that the lateral wall of the container has a circular cross section perpendicular to the rotation axis, and in that at least one fixed blade has a length greater than 50% of the radius of the container.

2. A device according to claim 1, in which the rotary stirring system comprises four stages of moving blades and three stages of fixed blades.

3. A device according to claim 1, in which a stage of fixed blades comprises two blades having the same longitudinal axis.

4. A device according to claim 3, in which the fixed blades of at least one fixed-blade stage are spaced apart by a distance of less than 25% of the diameter of the circular cross section.

5. A device according to claim 1, in which the fixed blades of the at least one fixed-blade stage each have a length greater than 90% of the radius of the container.

6. A device according to claim 1, in which at least one moving-blade stage comprises two blades that are symmetrical in relation to the rotation axis.

7. A device according to claim 6, in which the length of the moving blades of the at least one stage is greater than 75% of the radius of the circular cross section.

8. A device according to claim 1, in which the container comprises a bottom wall inclined downwards in the direction of an outlet conduit.

9. A device according to claim 8, in which the rotary stirring system comprises a stage of additional moving blades at a height level, along the rotation axis, corresponding to a junction zone between the lateral wall of the container and the bottom wall.

10. A device according to claim 9, in which the length of the additional moving blades is less than the length of the moving blades of the moving-blade stages.

11. A device according to claim 1, in which the fixed blades are all situated in the same plane containing the rotation axis.

12. A device according to claim 1, in which the moving blades are mounted on a single shaft.

13. A device according to claim 12, in which the shaft is mounted for rotation on the bottom wall.

14. A device according to claim 12, said shaft being mounted for rotation on a beam directed transversely to the rotation axis.

15. A device according to claim 14, in which the beam comprises a circuit for injecting a cooling fluid into the container.

16. A device according to claim 15, in which the beam is surmounted by a cover closing the top opening of the container.

17. A device according to claim 1, in which the moving blades are all situated in the same plane containing the rotation axis.

18. A device according to claim 12, in which the shaft is mounted for rotation on the bottom wall; and
in which the length of the moving blades of the at least one stage is greater than 75% of the radius of the circular cross section.

19. A device according to claim 13, said shaft being mounted for rotation on a beam directed transversely to the rotation axis.
